(19) United States
(12) Patent Application Publication
(10) Pub. No.: US 2023/0333892 A1
(43) Pub. Date: Oct. 19, 2023

(54) METHOD FOR DOCUMENTING COMPUTING STEPS OF A REAL TIME SYSTEM EXECUTED ON A COMPUTER CORE OF A PROCESSOR, PROCESSOR AND REAL TIME SYSTEM

(71) Applicant: dSPACE GmbH, Paderborn (DE)

(72) Inventors: Heiko KALTE, Paderborn (DE); Thorsten BREHM, Paderborn (DE); Dominik LUBELEY, Paderborn (DE)

(73) Assignee: dSPACE GmbH, Paderborn (DE)

(21) Appl. No.: 18/134,231

(22) Filed: Apr. 13, 2023

(30) Foreign Application Priority Data
Apr. 13, 2022 (DE) 10 2022 109 055.8

(51) Int. Cl. G06F 9/48; G06F 9/30

(52) U.S. Cl. CPC G06F 9/4887; G06F 9/3004

(57) ABSTRACT

A method for documenting computing steps of a real time system executed on a computer core of a processor, wherein tasks are executed on the computer core, which include one or more subtasks, and wherein during a computing step in each case a subtask of a task is executed. A first processor time is recorded at the beginning and a second processor time is recorded at the end of a computing step and time information dependent on the first and second processor times is stored in memory. The time information is stored in memory in such a way that it can be assigned to the subtask and the task that was executed during the computing step.

This nonprovisional application claims priority under 35 U.S.C. § 119(a) to German Patent Application No. 10 2022 109 055.8, which was filed in Germany on Apr. 13, 2022, and which is herein incorporated by reference.

### BACKGROUND OF THE INVENTION

### Field of the Invention

The application relates to a method for documenting computing steps of a real time system executed on a computer core of a processor as well as a processor and a real time system having such a processor.

### Description of the Background Art

A real time system is a system that must fulfill tasks, in particular computing tasks, e.g., for control and regulation, with time requirements, so-called real time requirements. For this purpose, the real time system comprises a computing unit with at least one processor, in particular a microprocessor. The processor has at least one computer core. The computer core is considered the central part of a processor. Many modern processors have multiple computer cores. A microprocessor with more than one complete computer core on a single chip is also known as a multi-core processor.

In real time systems, tasks to be processed are assigned to one computer core of the processor by means of a scheduler. The appropriate allocation of tasks to the processor is to enable compliance with real time requirements. In addition to periodic tasks that are periodically executed on the computer core, aperiodic tasks can also be provided that are executed on the computer core at a predefined event.

In real time systems, real time operating systems can be used, which are able to meet real time requirements of the tasks. This means that tasks are processed securely within a predetermined period of time. Real time operating systems can have schedulers for task scheduling.

EP 0567722 B1, which corresponds to U.S. Pat. No. 5,450,586, describes a method for dynamically characterizing and debugging a software system in which code markers can be activated for debugging. After activation, the code marker is saved with a time stamp when the software is executed again whenever an embedded software is called by a user program and when the embedded software is exited.

Control units in motor vehicles may comprise a computing unit, memory, interfaces and possibly other components required for processing input signals with input data into the control unit and generating control signals with output data. The interfaces are used to record the input signals or output the control signals.

Control units for driving functions in advanced driver assistance systems (ADAS=Advanced Driver Assistance Systems), e.g., for autonomous or semi-autonomous driving, can be tested when installed—for example in a motor vehicle as part of test drives. This is time-consuming, costly and many situations cannot be checked in a real environment because they only occur in extreme cases, such as accidents. For this reason, corresponding control units are tested in artificial environments, for example in test benches. A common test scenario here is to test the functionality of a control unit using a simulated environment, i.e., on the basis of a virtual spatial environment model. To this end, the environment of the control unit is calculated in parts or completely by means of a powerful simulation environment in real time. Frequently, the simulation environment records the output signals generated by the control unit and incorporates them into another real time simulation. Control units can thus be safely tested in a simulated environment under practically real conditions. How realistic the test is, depends on the quality of the simulation environment and the simulation calculated on it. Control units can thus be tested in a closed control loop, which is why such test scenarios are also referred to as hardware in-the-loop tests (hardware in-the-loop: HiL). Rapid Control Prototyping (RCP) is a computer-aided design method for rapid control development. Typical design steps in RCP include the (dynamic) description of the system to be automated and its modeling, the regulation and control design in the model, the implementation of the regulation and control design on the control unit, the testing of the solution in a pure simulation environment and on the real system.

Real time systems are used, for example, in rapid control prototyping (RCP) or hardware in-the-loop (HiL) systems, where strict real time requirements are imposed. Real time systems can be used both for environmental simulation and for the simulation of the control unit.

### SUMMARY OF THE INVENTION

It is therefore an object of the present invention to provide a method for documenting computing steps of a real time system executed on a computer core of a processor as well as a processor and a real time system having such a processor.

On a computer core of a processor of a real time system, tasks are executed which have one or more subtasks. A task has a sequence of computations to be executed by the computer core of the processor. The subtasks are portions of the task. During each computing step, a subtask of a task is executed.

In an exemplary method for documenting computing steps executed on the computer core, a first processor time at the beginning and a second processor time at the end of a computing step is recorded and time information dependent on the first and second processor times is stored in memory, e.g., a shared memory. For example, the time information stored in memory corresponds to the first and second processor times.

The time information is stored in memory in such a way that it can be assigned to a subtask and task that were executed during the computing step. Preferably, each subtask can be assigned to exactly one task.

During each computing step, one or at least one subtask is executed. The subtask is either partially or completely executed. In embodiments, after the end of the computing step, either a different subtask is executed or nothing is executed, since, for example, all pending subtasks have already been processed. The subtask of the following computing step following the subtask executed during a computing step may be assigned to the same task or to another task.

Here, the scanning of an input channel or the output of data to an output channel can each correspond to one subtask. Another subtask may concern the execution of the actual algorithm, which can be done, for example, as a mathematical model, e.g., a model for simulating a control unit or an environment of a control unit.

In example in which the first and second processor times are stored in memory, for example, the execution time of the subtask can be determined from the two processor times by assigning the first and second processor times stored in memory to exactly one subtask. The method offers the advantage that the time information stored in memory can be determined with very low computing power, since it depends on the processor time that already exists in the processor, e.g., in a processor register. The processor is not significantly additionally burdened by the storage of the time information. This makes it possible to let the time information be “run along” continuously during the execution of the actual task.

The advantage of the method is that time information on the processor times for the computing steps is permanently stored. These do not have to be globally synchronized, which saves effort. The collection of time information and the evaluation can then be bundled at a later date.

In an example, the processor time is a local time determined by the processor, which depends on the clocking of the processor. This embodiment can be further developed in different ways. For example, the processor time can be a timer or counter that is incremented after the processor is turned on. The advantage may be that, for example, no global coordinated time has to be determined, which would, for example, consume valuable computing time of the computer core and/or in which time could be lost due to coordination with remote hardware. In a further development, it is stipulated that the processor time is provided via a real time operating system, for example by means of a so-called “high resolution timer”, wherein a resolution in the order of nanoseconds, for example using a 64-bit time stamp is achieved. As a result, a high accuracy of the time information can be achieved.

In an example of the method, a user interface is provided with a user information dependent on the time information, wherein the user information depends in particular on the execution time of the computing step. Since the computing step can be assigned to the subtask and task that were executed during the computing step, quantitative information can be made available to the user via the user information, which in particular allows for conclusions to be drawn about the execution time of the computing step.

In an example of the method, the tasks comprise periodic tasks whose execution may be repeated with a period, wherein during a period one or more subtasks of the task are executed. Periodic tasks are repeated with a period and the real time system is designed such that all subtasks of a task are executed within a period.

The tasks include periodic tasks, whose execution is repeated with a period, and optionally aperiodic tasks, which can have soft or hard deadlines. Deadlines correspond to a maximum task execution time. Hard deadlines must be strictly met, soft deadlines can be observed with a certain tolerance. During aperiodic task execution, one or more subtasks can be executed.

If not all subtasks of a task can be executed up to a given deadline, e.g., within a period, this may constitute failure.

Time information for a predefined or specified number of computing steps per task can be stored in memory. This can mean, for example, that for each task, in particular an aperiodic task, a number of computing steps is predefined or specified, for which time information is stored in memory. Alternatively, or additionally, time information on the computing steps of a predefined or specified number of periods per task is stored in memory. This can mean, for example, that a number of periods are specified or predefined for each periodic task, for which time information is stored in memory. It may be provided, for example, to store the time information for the last 10, 50, 100 or generally N computing steps in memory. For periodic tasks, for example, it is possible to store the time information for the computing steps that belong to the predefined number of periods, e.g., 3, 10 or generally N, in memory. As a result, certain historical data is available that allows for conclusions to be drawn about the time behavior of the real time system. The amount of time information stored per task may vary from task to task. This is particularly advantageous if you have very different task periods of different tasks, such as 1 ms and 10 μs. 10 task periods of the “faster” task are then within a task period of the “slower” task, so that it might be useful to choose the number of task periods, for which time information on computing steps is stored, differently for each task and depending on the task period. In particular, for example, the same duration can be considered for which time information is stored—e.g., 10×1 ms=10 ms fora task with 1 ms period and, correspondingly, 10000×10 μs=10 ms for a task with 10 μs period.

Several subtasks of a task can be combined into a group and the user information depends on the time information on the computing steps of the group of subtasks of the task. For example, a first group of subtasks can affect input operations. Here, the scanning of in each case one input channel can correspond to one subtask. The subtasks, which relate to the scanning of an input channel, are then assigned to the first group of subtasks. For example, a second set of subtasks can affect output operations. Here, the output on one output channel can correspond to one subtask at a time. The subtasks, which relate to the output to an output channel, are then assigned to the second group of subtasks. Another group of subtasks can concern the execution of the actual algorithm, e.g., to simulate a control unit or an environment of a control unit. The subtasks, which refer to the actual algorithm, are then assigned to the further group of subtasks.

The real time system can simulate an automatic control or a simulated technical environment comprising an internal control. A subtask of the task or a group of subtasks of the task affect a control algorithm of the automatic control or internal control. If, for example, the real time system simulates an environment of a vehicle control unit, the subtask of the task or the group of subtasks of the task relates to an internal control algorithm that is executed for the simulation of the environment.

Components of the user information can be computed using time information stored in memory for a plurality of computing steps, wherein the computation comprises in particular the computation of average values, minimum values and/or maximum values. The computation of the components of the user information using time information stored in memory for several computing steps may relate in particular to statistics of the time information. In particular, sudden and/or one-time and/or large deviations can be output in an easily detectable format on the user interface.

An end event can be received, which depends on completion of the execution of computing steps. After receiving the end event, the components of the user information are computed, which is carried out using time information stored in memory for several computing steps. For example, an end event might involve manual intervention in the execution of the computation, such as a user canceling the computation. In such a case, for example, the end event is received by the user interface. For example, an end event might include stopping the execution of the computation because, for example, a simulation time has elapsed. In such a case, the end event is received by the computer core and/or the processor, for example, by a higher-level system. For example, an end event might include stopping the execution of the computation because, for example, time constraints are not being met. This is the case, for example, if a periodic task cannot be processed within a period duration. In such a case, the end event is received by the computer core and/or the processor, for example, by a higher-level system. For example, an end event may include that the execution of the computation is terminated because, for example, the computation result has been achieved or a predetermined simulation duration has been reached. In such a case, the end event is received by the computer core and/or the processor, for example, by a higher-level system. Preferably, the computation of the components of the user information is started depending on the end event, for example, after receipt of the end event. In a further development of the invention, the computation of the components of the user information is started only after the end event has been received. After receiving the end event, the computer core is no longer busy executing the tasks. Now there is time to perform the computations using the time information and to output the results. The advantage is that the system is not burdened by computations that serve to analyze documentation and errors during the execution of the tasks.

This makes it possible, for example, to provide the user with a metric with which he can, for example, after a task overrun, see at first glance which subtask is the cause of the task overrun. A task overrun is an example of an end event in which a periodic task could not be completely executed within its period. The time information is stored in memory and can be made available to the user at any time and thus, for example, directly after a task overrun. No additional software is required, which must be executed parallel to the actual software to analyze the software execution. An end event, e.g., task overrun, which may occur sporadically and/or only hours later, does not have to be simulated with another run with such an analyzer. Due to the simple execution, the time overhead of the described method is low and is therefore also suitable for debugging tasks with extremely short turnaround times in the range of, e.g., 10 μs.

The plurality of computing steps used to compute the components of the user information are assigned to a subtask of a task and/or a group of subtasks of a task. This makes it possible to further simplify readability for the user if, for example, all input operations or output operations are combined and, for example, statistics are output together.

In an example of the method, there are tasks of different priority. The execution of a subtask of a task of a lower priority can be interrupted by the execution of a subtask of a task of a higher priority, wherein the user information includes the duration of the interrupt of the execution of the task of a lower priority. The output of the interrupt duration of a task allows for the user to draw further conclusions about the behavior of the real time system.

A further subtask or group of subtasks of a task can relate to an interrupt of the task. In particular, this means that not only statistics such as execution durations for the groups of subtasks such as input, output, algorithm are output as user information, but also statistics for interrupt times of the task. This is especially relevant for low-priority tasks that can be interrupted by higher-priority tasks.

The user information can be displayed permanently, continuously in a graphical data output of a user interface. This can require more computing time as compared to the previously described process of outputting the user information and will therefore usually impair the desired efficiency and speed of the method. This embodiment can therefore be considered in particular for special applications where sufficient computing power and speed is available in the overall system.

A processor with at least one computer core may be programmed to execute one of the methods described above. A real time system has at least one such processor. Preferably, a real time system has interfaces, for example to a user interface, and a computing unit having at least one such processor.

The application further relates to a computer program product which has instructions which, when executed on a processor having at least one computer core, execute one of the methods described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows computing steps executed schematically on a computer core;

FIG. 2 is a schematic representation of an embodiment of a real time system;

FIG. 3 is a schematic representation of a further embodiment of a real time system;

FIG. 4 shows, schematically, the execution of two periodic tasks;

FIG. 5 is a schematic representation of an embodiment of a user interface; and

FIGS. 6A and 6B are schematic representations of possible selection areas of the user interface.

### DETAILED DESCRIPTION

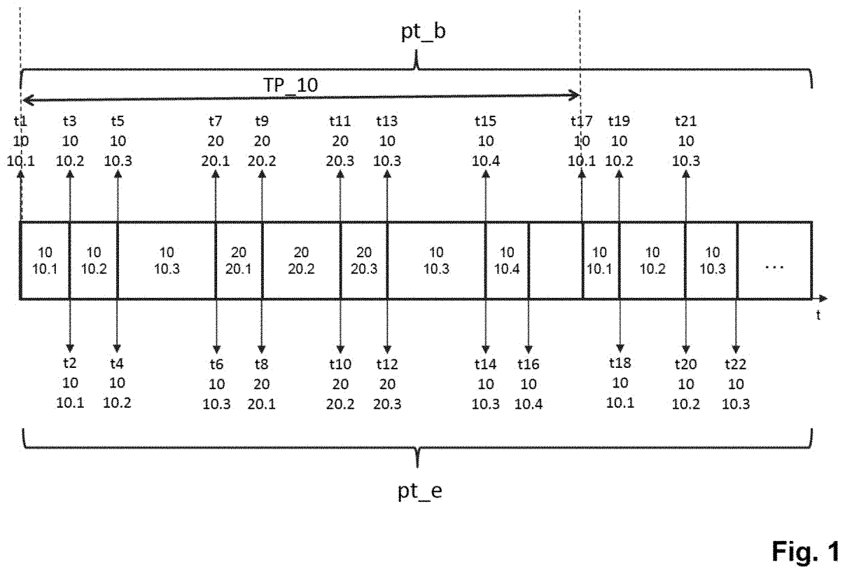

FIG. 1 shows exemplary computing steps on a time axis t, as they are executed by a computer core of a processor. At the beginning of each computing step, a respective first processor time pt_b is stored in memory. At the end of each computing step, a respective second processor time pt_e is stored in memory. FIG. 1 shows the tasks 10, 20 and the subtasks 10.1, 10.2, 10.3., 10.4, 20.1, 20.2, 20.3 by way of example. In the actual real time system, more tasks can be handled, and a task can also have more than the displayed subtasks.

In the example shown, at the beginning of the execution of the subtask 10.1 of the task 10, i.e., when the computing step begins in which the subtask 10.1 is executed, the first processor time t1 is stored. The storage of the first processor time t1 is carried out in such a way that it can be assigned to the subtask 10.1 of the task 10. This can be done, for example, by storing the first processor time t1 together with an identification of the subtask 10.1 and the task 10. The identification of the subtask can be done via an additional piece of stored information, or, for example, by a defined memory location, e.g., within a ring buffer for, e.g., N task executions for all subtasks of all tasks. The “N” in this context stands for an integer. In one embodiment, the identification of the subtask and the task can be done via the address of the memory location. The address can be used to identify which subtask is assigned to each processor time. It is possible here to use cyclically writable memory, in which, for example, the processor times of equal subtasks of a task are stored on a respective assigned memory location. In further embodiments of the invention, different methods can be provided to evaluate the stored processor times in the chronologically correct order and to assign the corresponding subtasks and tasks chronologically. In particular, the processor times themselves already contain time information that can be used to determine the chronological order. The same procedure is followed for the first processor times t3, t5, t7, t9, t11, t13, t15, t17, t19, t21 and the respective assigned tasks 10, 20 and subtasks 10.1, 10.2, 10.3., 10.4, 20.1, 20.2, 20.3.

At the end of the execution of the subtask 10.1 of the task 10, i.e., when the computing step ends in which the subtask 10.1 was executed, the second processor time t2 is stored. The storage of the second processor time t2 is carried out in such a way that it can be assigned to the subtask 10.1 of the task 10. This can be done, for example, by storing the second processor time t2 together with an identification of the subtask 10.1 and the task 10. The identification of the subtask can be done via an additional stored information, or, for example, by a defined memory location, e.g., within a ring buffer for N task executions for all subtasks of all tasks. In one embodiment, the subtask and the task can be identified via the address of the memory location. The address can be used to identify which subtask is assigned to each processor time. It is possible here to use cyclically writable memory, in which, for example, the processor times of equal subtasks of a task are stored on a respective assigned memory location. In different developments of the invention, different methods can be used to evaluate the stored processor times in the chronologically correct order and to assign them chronologically to the corresponding subtasks and tasks. In particular, the processor times themselves already contain time information that can be used to determine the chronological order. The same procedure is followed for the second processor times t4, t6, t8, t10, t12, t14, t16, t18, t20, t22 and the respective assigned tasks 10, 20 and subtasks and the respective assigned tasks 10, 20 and subtasks 10.1, 10.2, 10.3., 10.4, 20.1, 20.2, 20.3.

For example, the first processor time t15 is stored at the beginning of the execution of the subtask 10.4 of the task 10. The second processor time t16 is stored at the end of the execution of the subtask 10.4 of the task 10. After that, there is no task execution on the computer core. At processor time t17, the execution of the subtask 10.1 begins, so the first processor time t17 is stored. At processor time t18, the execution of the subtask 10.1 ends, so the second processor time t18 is stored. The task 10 is a periodic task. The re-execution of the task 10 starts after the expiration of the period TP_10.

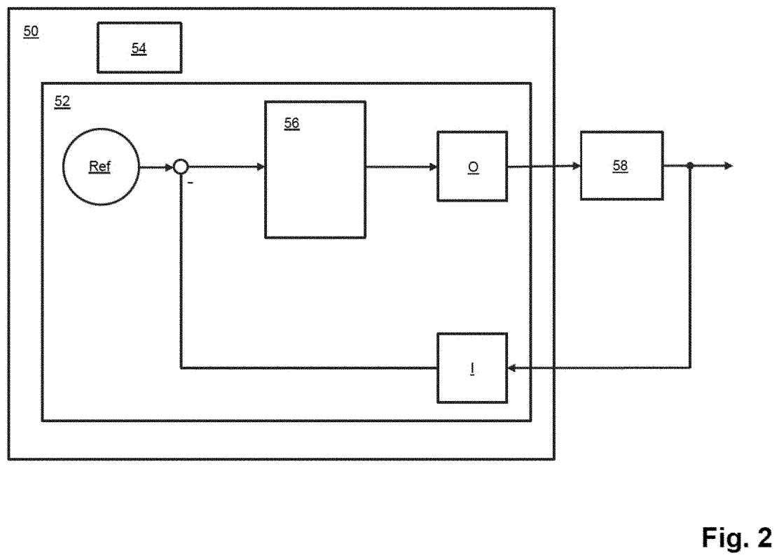

FIG. 2 shows a real time system 50, which is designed as a simulator of an at least partially simulated environment of a control unit 58 to be tested. The real time system 50 can, in particular, simulate the technical environment of the control unit 58, for example, the sensors and actuators of the control unit 58. The simulator 50 comprises at least one interface 54, via which, for example, a user interface HMI can be connected.

The real time system 50 has at least one computing unit 52 with at least one processor. The processor has at least one computer core. Preferably, a real time operating system runs on the computing unit 52, which comprises a scheduler via which subtasks 10.1, 10.2, 10.3., 10.4, 20.1, 20.2, 20.3 of tasks 10, 20 are assigned to the computer core.

On the computing unit 52, a mathematical model of the environment of the control unit 58 is executed as the control algorithm on the automatic control 56 with the control unit 58 as the controlled system. The output O of the computing unit 52 is provided to the control unit 58, for example, as simulated sensor values. Processing the output O, for example, includes driver calls when updating the output channels of the computing unit 52. Values of actuators of the control unit 58 are provided to the computing unit 52 as input I. Processing the input I, for example, includes driver calls when updating/scanning the input channels of the computing unit 52. To execute the control algorithm, reference variables Ref are fed to the model code executable on the automatic control 56, from which the values of the input I are subtracted. In the present context, the model code is executable computer code based on said mathematical model. In the illustrated embodiment of the real time system 50, one/multiple predefined control task/s can be fulfilled by means of the model code.

The execution of the control algorithm is divided into the previously described tasks 10, 20. Subtasks 10.1, 10.2, 10.3, 10.4, 20.1, 20.2, 20.3 may concern, for example, the input I, the output O and/or the execution of the controller model 56.

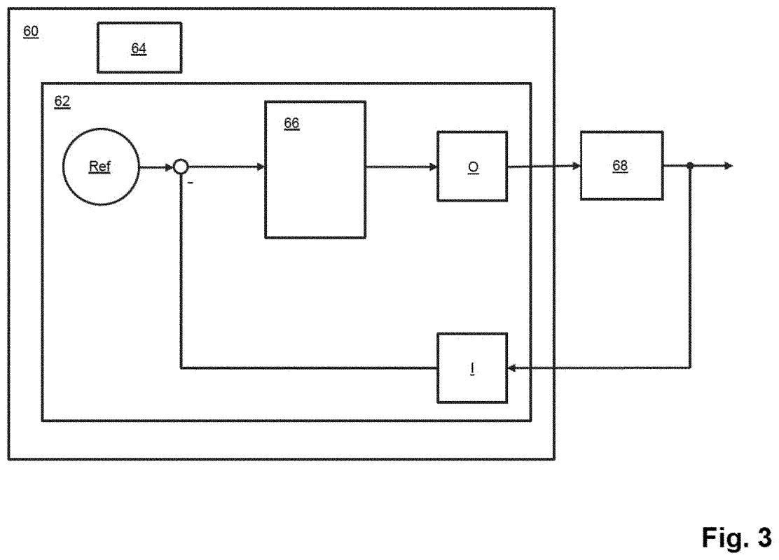

FIG. 3 shows a real time system 60, which is designed as a simulator of a prototype control unit, e.g., for a vehicle, acting on an object to be controlled, e.g., an internal combustion engine, as a controlled system. The real time system 60 can be used in particular for simulating various development steps of a control unit 58, in particular a model-based control design. The real time system 60 can thus represent a prototype control unit in each development phase. The simulator 60 comprises at least one interface 64, via which, for example, a user interface HMI can be connected.

The real time system has at least one computing unit 62 with at least one processor. The processor has at least one computer core. Preferably, a real time operating system runs on the computing unit 62, which has a scheduler via which subtasks 10.1, 10.2, 10.3., 10.4, 20.1, 20.2, 20.3 of tasks 10, 20 are assigned to the computer core.

On the computing unit 62, a mathematical model of the control task of the prototype control unit is executed as a control algorithm on the automatic control 66, with the object 68 to be regulated/controlled as the controlled system. The output O of the computing unit 62 is provided to the object 68, for example, as the output of the prototype control unit, e.g., value of an actuator. Processing the output O, for example, includes driver calls when updating the output channels of the computing unit 62. Output values of the object 68 are provided to the computing unit 62 as input I. Processing the input I, for example, includes driver calls when updating/scanning the input channels of the computing unit 62. Reference variables Ref are fed to the automatic control 66 to execute the control algorithm, from which the values of the input I are subtracted.

The execution of the control algorithm is divided into the previously described tasks 10, 20. Subtasks 10.1, 10.2, 10.3, 10.4, 20.1, 20.2, 20.3 may concern, for example, the input I, the output O and/or the execution of the controller model 66.

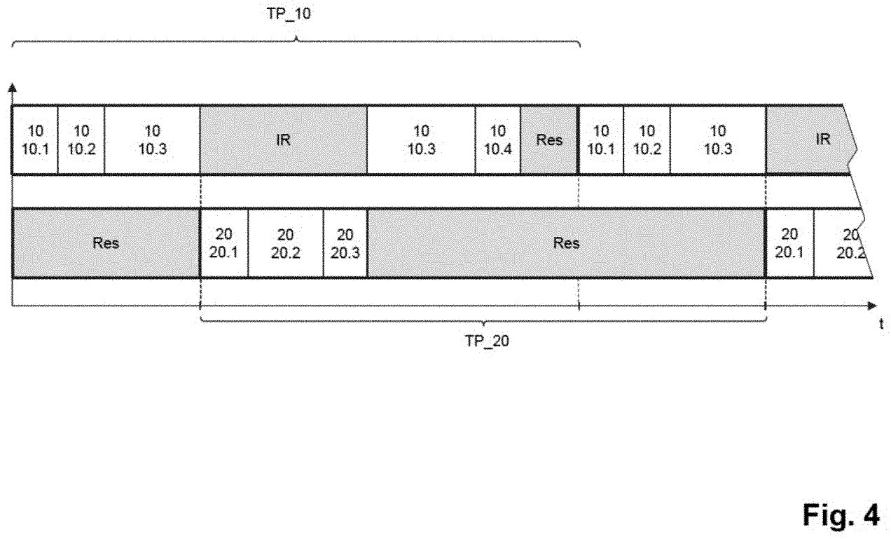

FIG. 4 is an example of computing steps on a time axis t, the way they are executed by a computer core of a processor. The subtasks 10.1, 10.2, 10.3, 10.4, 20.1, 20.2, 20.3 highlighted in white are executed on the computer core. The grey highlighted parts IR, Res refer to periods in which the respective task is not being currently executed. The scheduler of the operating system assigns the subtasks of the respective task 10, 20 to be executed to the computer core for execution.

The executed computing steps concern two periodic tasks 10, 20 of different priority. The task 10 has the period TP_10 and is of lower priority than task 20. The task 20 has a period TP_20. At the end of each period, TP_10, TP_20, in each case a reserve is provided in which no subtask is provided for execution.

First, the subtasks 10.1, 10.2, 10.3 of the task 10 are executed in the example shown. Meanwhile, the task 20 has no subtasks that are executed. At the beginning of the period TP_20 of the task 20, the execution of the subtask 10.3 of the task 10 is interrupted and the subtasks 20.1, 20.2, 20.3 of the task 20 are successively brought to execution on the computer core. During this time, the execution of the task 10 is interrupted, represented by the gray highlighted interrupt time IR of the task 10. If the execution of the subtasks 20.1, 20.2, 20.3 of the task 20 is completed, the rest of the subtask 10.3 is executed and then the subtask 10.4. After the execution of the subtask 10.4, the execution of the task 10 is finished. During the reserve time Res, no subtask is executed on the computer core. After that, after the end of the period TP_10 of the task 10, the execution of the task 10 starts again with the subtask 10.1.

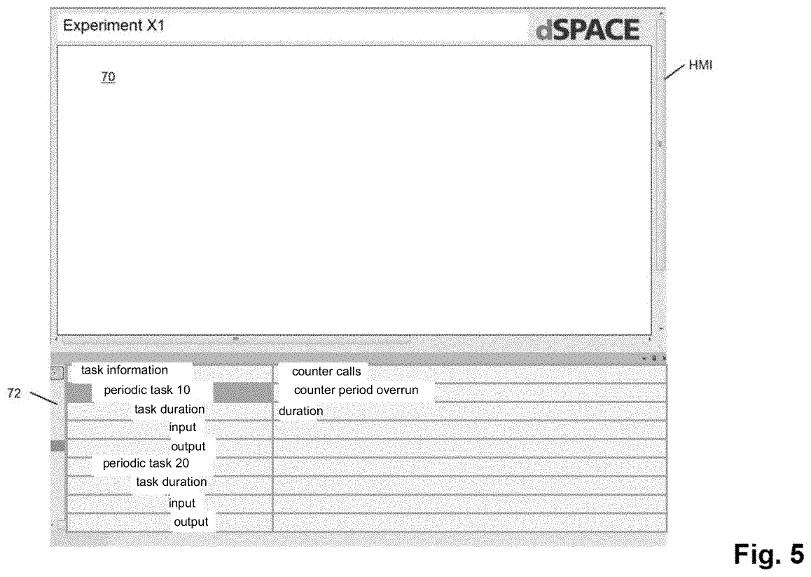

FIG. 5 shows an example of a graphical user interface HMI. The user interface HMI has an area 70 for graphical data output and a selection area 72.

In the area 70, user information on values and variables processed in the real time system can be output, which can be done in various graphical forms, e.g., as plots. In the selection area 72, the selection can be made in the area 70 for information to be displayed.

In the example shown, selectable user information on the documented time information for various tasks of a real time system 50, 60 is shown in the area 72. Information selected via the area 72 can then be displayed graphically, for example, in the area 70.

For periodic tasks, there is selectable information on the number of calls of the task, the number of period overruns and the duration (right column of area 72). For the task duration, there are sub-items Input and Output (left column), which in turn can have substructures. In the displayed state, the “Periodic Task 10” is selected—indicated by the gray marking. The points of the left column “Counter Calls”, “Counter Period Overrun” and “Duration” belong to this selection (“Periodic Task 10”).

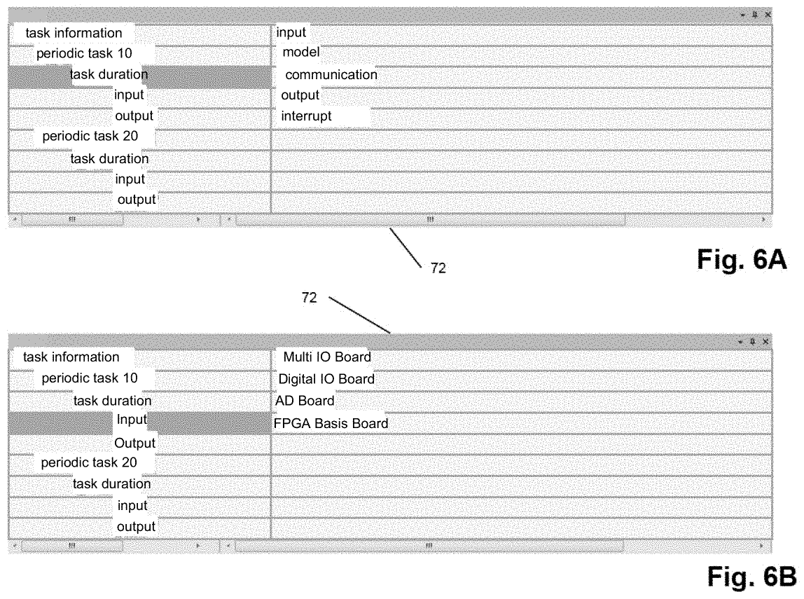

FIGS. 6A, 6B show further states of the selection area 72.

In FIG. 6A, the “Task Duration” of the periodic task 10 is selected in the left column. The right column shows the possible output information, which includes time information for different task durations of the periodic task 10. Possible time information here is “Input”, “Model”, “Communication”, “Output” and “Interrupt”. The respective selection points on the right side can correspond to groups of subtasks, in which, for example, all subtasks relating to the input are bundled or all subtasks relating to the output are bundled. The item “Interrupt” concerns, for example, the duration during which the periodic task 10 was interrupted, e.g., because of another task of higher priority (see FIG. 4).

In FIG. 6B, the item “Input” of the item “Task Duration” of the periodic task 10 is selected in the left column. The sub-items of the item “Input” shown in the right column concern different input channels. The reading of each of the input channels corresponds to a subtask of the periodic task 10 and the group of the different subtasks for the different input channels can be processed into common user information for the “Input” for the periodic task.

In the following, user information is shown by way of example as to how it can be output to a user for time information. The following illustration is text-based. It can be output as text, for example, on the output area 70 or converted into a graphical form.

User information for three periods n, n−1 and n−2 is displayed for the periodic task 10 with the period TP_10 of 1 ms and the periodic task 20 with the period TP_20 of 10 μs. The information in brackets after the subtasks and/or groups of subtasks correspond to the minimum, maximum and average times. This statistical information becomes more meaningful as the number of periods under consideration increases.

| Periodic Task 10 (1 ms) | Period n | Period n-1 | Period n-2 |
|---|---|---|---|
| Counter Calls | 2375472 | 2375471 | 2375470 |
| Counter Period Overrun | 0 | 0 | 0 |
| Task Duration | 189.73 μs | 189.53 μs | 189.89 μs |
| (189.53 μs, 189.89 μs, 189.72 μs) | | | |
| Input (12.43 μs, 12.61 μs, 12.52 μs) | 12.53 μs | 12.43 μs | 12.61 μs |
| Multi I/O Board | 3.40 μs | 3.38 μs | 3.42 μs |
| Digital I/O Board | 1.20 μs | 1.18 μs | 1.22 μs |
| DS6221 A/D Board | 2.94 μs | 2.91 μs | 2.96 μs |
| FPGA Basis Board | 4.99 μs | 4.96 μs | 5.01 μs |
| Model (59.21 μs, 59.24 μs, 59.23 μs) | 59.21 μs | 59.23 μs | 59.24 μs |
| Communication | 8.37 μs | 8.39 μs | 8.38 μs |
| (8.37 μs, 8.39 μs, 8.38 μs) | | | |
| Output (21.99 μs, 22.03 μs, 22.01 μs) | 22.01 μs | 21.99 μs | 22.03 μs |
| Multi I/O Board | 5.68 μs | 5.69 μs | 5.71 μs |
| Digital I/O Board | 4.17 μs | 4.16 μs | 4.17 μs |
| A/D Board | 7.11 μs | 7.10 μs | 7.09 μs |
| FPGA Basis Board | 4.05 μs | 4.04 μs | 4.06 μs |
| Interrupt | 87.61 μs | 87.53 μs | 87.63 μs |
| (87.53 μs, 87.63 μs, 87.59 μs) | | | |
| Periodic Task 20 (10 μs) | Period n | Period n-1 | Period n-2 |
| Counter Calls | 237547234 | 237547233 | 237547232 |
| Counter Period Overrun | 1 | 0 | 0 |
| Task Duration | 11.23 μs | 9.25 μs | 9.31 μs |
| (9.25 μs, 11.23 μs, 9.93 μs) | | | |
| Input (3.39 μs, 3.42 μs, 3.41 μs) | 3.41 μs | 3.39 μs | 3.42 μs |
| Multi I/O Board | 0.44 μs | 0.43 μs | 0.42 μs |
| Digital I/O Board | 0.31 μs | 0.32 μs | 0.31 μs |
| A/D Board | 1.12 μs | 1.11 μs | 1.10 μs |
| FPGA Basis Board | 1.54 μs | 1.53 μs | 1.59 μs |
| Model (3.23 μs, 5.21 μs, 3.90 μs) | 5.21 μs | 3.23 μs | 3.25 μs |
| Communication | 0.52 μs | 0.51 μs | 0.50 μs |
| (0.50 μs, 0.52 μs, 0.51 μs) | | | |
| Output (2.09 μs, 2.16 μs, 2.12 μs) | 2.09 μs | 2.12 μs | 2.16 μs |
| Multi I/O Board | 0.28 μs | 0.29 μs | 0.31 μs |
| Digital I/O Board | 0.17 μs | 0.18 μs | 0.17 μs |
| A/D Board | 0.73 μs | 0.71 μs | 0.75 μs |
| FPGA Basis Board | 0.91 μs | 0.94 μs | 0.93 μs |
| Interrupts (0.00 μs, 0.00 μs, 0.00 μs) | 0.00 μs | 0.00 μs | 0.00 μs |

In the tables shown, the subtask “Model” is, for example, an executed model code of an automatic control 56 or 66 for the realization of a control algorithm, i.e., the core of the calculation. Different simulations may be other calculated mathematical models. The numbers for periodic task 20 underlined in the table above in the rows “Counter Period Overrun”, “Task Duration” and “Model” in the column “Periods n” can be output on the user interface HMI, e.g., by coloring, font design or the like. In this way, the user information can be supplemented by information on possible causes of a possible error event.

The underlined “1” in the column “Period n” of the row “Period Overrun” of the task 2 indicates that in a period the periodic task 20 could not be executed within its period and therefore a so-called overrun of the period occurred. This may constitute a failure. The underlined “1” in the embodiment of the table is thus the proof that exactly one period overrun has taken place. Optionally, it may be provided that the real time system is set up to tolerate a predefined overrun number Mx of period overruns before an end event occurs.

In row “Task duration” of the column “Periods n”, the execution time of 11.23 μs is underlined. This execution time exceeds the limit of 10 μs specified by the period duration. In the row “Model” of the column “Period n” the number 5.21 μs is underlined. This execution time for the “Model” subtask deviates greatly from the execution times in the other columns “Period n−1”: and “Period n−2”. Such a large deviation from a series of “usual” task/subtask times can be an indication of causes of actual or impending period overruns. The marking—here by underlining—can be used to indicate this.

A marked output on the user interface can thus be used on the one hand to indicate the period overrun (lines “Counter Period Overrun” and “Task Duration”) and on the other hand to indicate such a possible cause of the period overrun (line “Model”).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for documenting computing steps of a real time system executed on a computer core of a processor, the method comprising:
executing tasks on the computer core, the tasks comprise one or more subtasks, wherein during a computing step in each case a subtask of a task is executed;
recording a first processor time at a beginning of a computing step;
recording a second processor time at an end of a computing step; and
storing a time information based on the first and the second processor time in memory, the time information being stored in the memory such that it corresponds to the subtask and the task that was executed during the computing step.

2. The method according to claim 1, wherein the processor time is a local time determined by the processor, which depends in particular on the clocking of the processor.

3. The method according to claim 1, wherein a user interface is provided with a user information dependent on the time information, wherein the user information is based on the execution time of the computing step.

4. The method according to claim 1, wherein the tasks comprise periodic tasks, the execution of which is repeated with a period, and wherein, during a period, one or more subtasks of the task are executed.

5. The method according to claim 1, wherein time information on a number of computing steps predetermined or predefined per task is stored in memory and/or time information on the computing steps of a number of periods predetermined or predefined per task is stored in memory.

6. The method according to claim 5, wherein a plurality of subtasks of a task are combined into a group and the user information depends on the time information on the computing steps of the group of subtasks of the task.

7. The method according to claim 6, wherein an automatic control or a simulated technical environment, comprising an internal control, is simulated by the real time system and a subtask of the task or a group of subtasks of the task relate to a control algorithm of the automatic control or the internal control.

8. The method according to claim 5, wherein components of the user information are computed using time information stored in memory for a plurality of computing steps, and wherein the computation comprises a computation of average values, minimum values and/or maximum values.

9. The method according to claim 8, wherein an end event is received, which depends on the completion of the execution of computing steps, and wherein after receipt of the end event, the computation of the components of the user information takes place, which is carried out using time information stored in memory for a plurality of computing steps.

10. The method according to claim 9, wherein only after receipt of the end event, the computation of the components of the user information is carried out, which is carried out using time information stored in memory for a plurality of computing steps.

11. The method according to claim 9, wherein the plurality of computing steps used to compute the components of the user information are assigned to a subtask of a task and/or a group of subtasks of a task.

12. The method according to claim 1, wherein there are tasks of different priority and the execution of a subtask of a task of a lower priority is interrupted by the execution of a subtask of a task of a higher priority, and wherein the user information comprises the duration of the interrupt of the execution of the lower priority task.

13. The method according to claim 11, wherein a further subtask or a further group of subtasks of a task concerns an interrupt of the task.

14. A processor comprising at least one computer core, wherein the processor is programmed to execute the method according to claim 1.

15. A real time system comprising at least one processor according to claim 14.

16. A computer program product comprising instructions which, when executed on a processor, carry out the method according to claim 1.
